(19) United States
(12) Patent Application Publication
(10) Pub. No.: US 2024/0037214 A1
(43) Pub. Date: Feb. 1, 2024

(54) INFORMATION PROCESSING DEVICE, INFORMATION PROCESSING METHOD, AND COMPUTER READABLE MEDIUM

(71) Applicant: Mitsubishi Electric Corporation, Tokyo (JP)

(72) Inventor: Masahiro FUJITA, Tokyo (JP)

(73) Assignee: Mitsubishi Electric Corporation, Tokyo (JP)

(21) Appl. No.: 18/378,883

(22) Filed: Oct. 11, 2023

Related U.S. Application Data
(63) Continuation of application No. PCT/JP2021/019271, filed on May 20, 2021.

(51) Int. Cl. G06F 21/45; G06F 21/31

(52) U.S. Cl. CPC G06F 21/45; G06F 21/31

(57) ABSTRACT

A policy acquisition unit (104) acquires a password policy prescribed in an authentication system (200) that performs user authentication using a password. A policy presentation unit (105) presents the password policy acquired by the policy acquisition unit (104) to a user when the authentication system (200) is to accept an input of a password from the user for the user authentication.

### CROSS REFERENCE TO RELATED APPLICATIONS

This application is a Continuation of PCT International Application No. PCT/JP2021/019271, filed on May 20, 2021, all of which is hereby expressly incorporated by reference into the present application.

### TECHNICAL FIELD

The present disclosure relates to user authentication using a password.

### BACKGROUND ART

There are authentication systems that perform user authentication using passwords, as typified by a technique described in Patent Literature 1.

In an authentication system using passwords, it is often arranged that in order for a user to use a strong password, a password policy is set by the authentication system and the user is made to generate a password in accordance with the password policy. The password policy is rules for generating a password. The password policy prescribes, for example, types of characters to be used in a password (“alphabets only”, “combination of alphabets and numbers”, etc.), conditions on the number of characters in a password (“8 or more characters and less than 16 characters”, etc.), and so on.

### CITATION LIST

### Patent Literature

Patent Literature 1: JP 2007-310515 A

### SUMMARY OF INVENTION

### Technical Problem

In existing authentication systems, a password policy is often displayed on a password registration page (hereafter referred to simply as the “registration page”) for a user to register a password so as to notify the user of the password policy.

On the other hand, in the existing authentication systems, a password policy is not displayed on a password authentication page (hereafter referred to simply as the “authentication page”) for user authentication using a password.

In this way, in the existing authentication systems, the password policy is displayed on the registration page, but the password policy is not displayed on the authentication page.

Therefore, a problem is that the user cannot enter a correct password in the authentication page when being authenticated and fails in user authentication.

The present disclosure mainly aims to solve the above problem. More specifically, the present disclosure mainly aims to allow a user to enter a correct password in an authentication page in user authentication.

### Solution to Problem

An information processing device according to the present disclosure includes
a policy acquisition unit to acquire a password policy prescribed in an authentication system that performs user authentication using a password; and
a policy presentation unit to present the password policy acquired by the policy acquisition unit to a user when the authentication system is to accept an input of a password from the user for the user authentication.

### Advantageous Effects of Invention

According to the present disclosure, a user can enter a correct password in an authentication page in user authentication.

### BRIEF DESCRIPTION OF DRAWINGS

FIG. 1 is a diagram illustrating an example of a system configuration according to Embodiment 1;

FIG. 2 is a diagram illustrating an example of a hardware configuration of a user terminal device according to Embodiment 1;

FIG. 3 is a diagram illustrating an example of a functional configuration of a policy acquisition device according to Embodiment 1;

FIG. 4 is a diagram illustrating an example of an authentication page according to Embodiment 1;

FIG. 5 is a diagram illustrating an example of a registration page according to Embodiment 1;

FIG. 6 is a flowchart illustrating an example of operation of the policy acquisition device according to Embodiment 1;

FIG. 7 is a diagram illustrating an example of html source code of the authentication page according to Embodiment 1;

FIG. 8 is a flowchart illustrating a registration page acquisition procedure according to Embodiment 1;

FIG. 9 is a diagram illustrating an example of html source code of the registration page according to Embodiment 1;

FIG. 10 is a flowchart illustrating a password policy acquisition procedure according to Embodiment 1;

FIG. 11 is a diagram illustrating an example of an authentication page including a password policy according to Embodiment 1;

FIG. 12 is a flowchart illustrating an example of operation of the policy acquisition device according to Variation 1 of Embodiment 1;

FIG. 13 is a diagram illustrating an example of a registration page according to Variation 2 of Embodiment 1;

FIG. 14 is a diagram illustrating an example of an error registration page according to Variation 2 of Embodiment 1;

FIG. 15 is a diagram illustrating an example of the error registration page according to Variation 2 of Embodiment 1;

FIG. 16 is a diagram illustrating an example of html source code of the registration page according to Variation 2 of Embodiment 1;

FIG. 17 is a diagram illustrating an example of a DOM according to Variation 2 of Embodiment 1;

FIG. 18 is a diagram illustrating an example of the DOM according to Variation 2 of Embodiment 1;

FIG. 19 is a flowchart illustrating an example of operation of the policy acquisition device according to Variation 2 of Embodiment 1;

FIG. 20 is a diagram illustrating an example of the DOM according to Variation 2 of Embodiment 1;

FIG. 21 is a diagram illustrating an example of the DOM according to Variation 2 of Embodiment 1;

FIG. 22 is a diagram illustrating an example of an error message according to Variation 2 of Embodiment 1;

FIG. 23 is a diagram illustrating an example of the system configuration according to Embodiment 2;

FIG. 24 is a diagram illustrating an example of the functional configuration of the policy acquisition device according to Embodiment 2;

FIG. 25 is a flowchart illustrating an example of operation of the policy acquisition device according to Embodiment 2;

FIG. 26 is a diagram illustrating an example of a functional configuration of the policy acquisition device according to Variation 1 of Embodiment 2;

FIG. 27 is a flowchart illustrating an example of operation of the policy acquisition device according to Variation 1 of Embodiment 2;

FIG. 28 is a diagram illustrating an example of the system configuration according to Variation 3 of Embodiment 1; and

FIG. 29 is a diagram illustrating an example of the system configuration according to Variation 3 of Embodiment 1.

### DESCRIPTION OF EMBODIMENTS

Embodiments will be described hereinafter using the drawings. In the following description and drawings of the embodiments, parts denoted by the same reference sign indicate the same part or equivalent parts.

### Embodiment 1

***Description of Configurations***

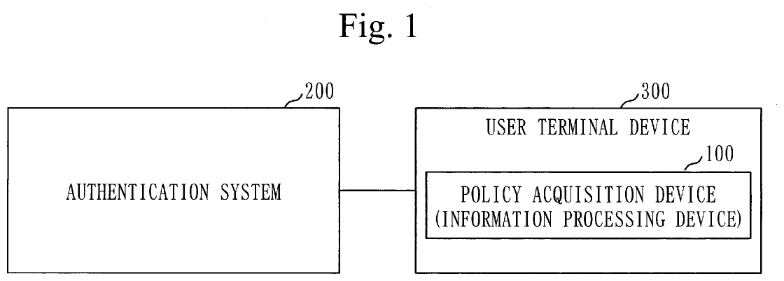

FIG. 1 illustrates an example of a system configuration according to this embodiment.

An authentication system 200 is a server device that performs user authentication using a password. A password policy is prescribed in the authentication system 200.

A user terminal device 300 is a terminal device used by a user who is to be authenticated by the user authentication.

The user terminal device 300 includes a policy acquisition device 100. In the user authentication, the policy acquisition device 100 acquires the password policy from the authentication system 200. Then, the policy acquisition device 100 presents the acquired password policy to the user.

The policy acquisition device 100 is equivalent to an information processing device. A procedure for operation of the policy acquisition device 100 is equivalent to an information processing method. A program that realizes the operation of the policy acquisition device 100 is equivalent to an information processing program.

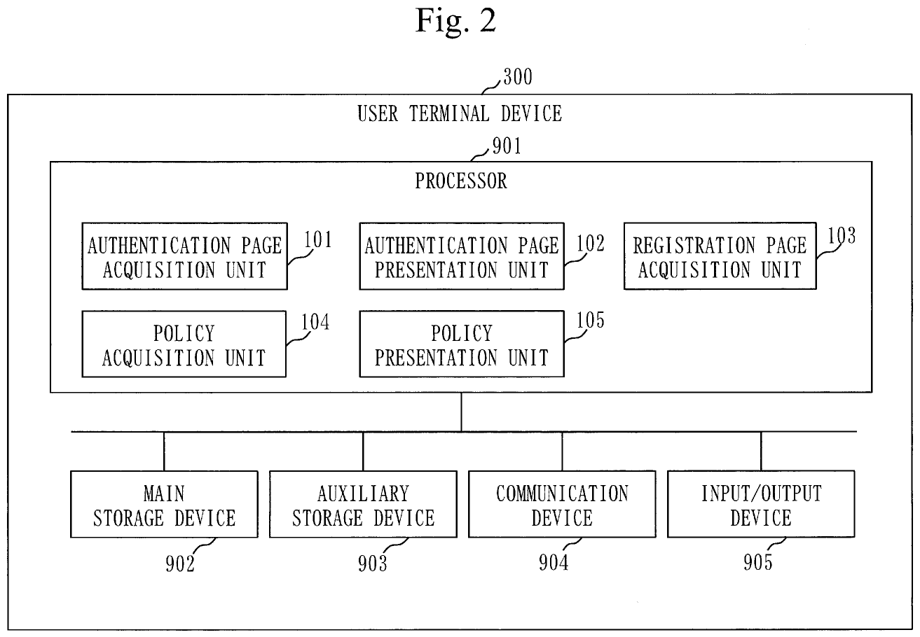

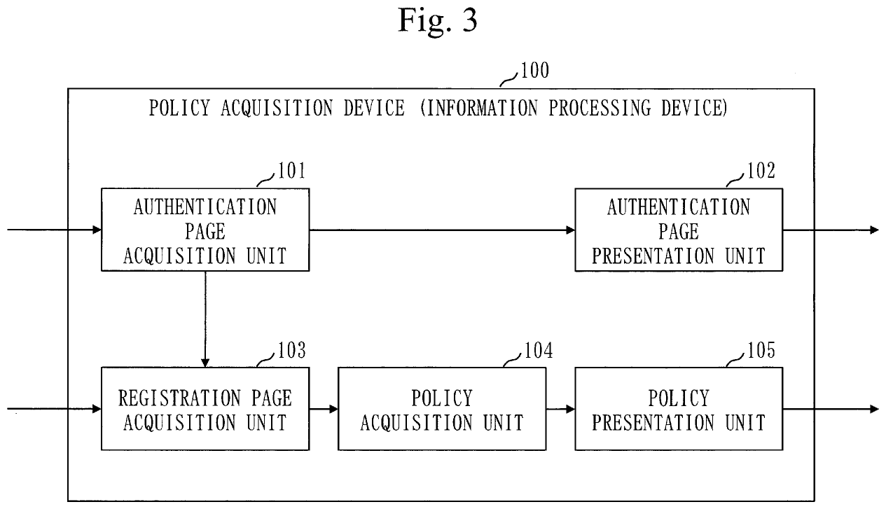

FIG. 2 illustrates an example of a hardware configuration of the user terminal device 300 according to this embodiment. FIG. 3 illustrates an example of a functional configuration of the policy acquisition device 100 according to this embodiment.

Referring to FIG. 2, an example of the hardware configuration of the user terminal device 300 will be described first.

The user terminal device 300 according to this embodiment is a computer.

The user terminal device 300 includes, as hardware, a processor 901, a main storage device 902, an auxiliary storage device 903, a communication device 904, and an input/output device 905.

As illustrated in FIG. 3, the policy acquisition device 100 includes, as functional components, an authentication page acquisition unit 101, an authentication page presentation unit 102, a registration page acquisition unit 103, a policy acquisition unit 104, and a policy presentation unit 105.

The functions of the authentication page acquisition unit 101, the authentication page presentation unit 102, the registration page acquisition unit 103, the policy acquisition unit 104, and the policy presentation unit 105 are realized, for example, by programs.

The auxiliary storage device 903 stores the programs that realize the functions of the authentication page acquisition unit 101, the authentication page presentation unit 102, the registration page acquisition unit 103, the policy acquisition unit 104, and the policy presentation unit 105.

These programs are loaded from the auxiliary storage device 903 into the main storage device 902. Then, the processor 901 executes these programs to perform operation of the authentication page acquisition unit 101, the authentication page presentation unit 102, the registration page acquisition unit 103, the policy acquisition unit 104, and the policy presentation unit 105 to be described later.

FIG. 3 schematically represents a state in which the processor 901 is executing the programs that realize the functions of the authentication page acquisition unit 101, the authentication page presentation unit 102, the registration page acquisition unit 103, the policy acquisition unit 104, and the policy presentation unit 105.

The user terminal device 300 also includes functions other than the authentication page acquisition unit 101, the authentication page presentation unit 102, the registration page acquisition unit 103, the policy acquisition unit 104, and the policy presentation unit 105. However, these functions other than the authentication page acquisition unit 101, the authentication page presentation unit 102, the registration page acquisition unit 103, the policy acquisition unit 104, and the policy presentation unit 105 are not directly related to the description of this embodiment, so that only the authentication page acquisition unit 101, the authentication page presentation unit 102, the registration page acquisition unit 103, the policy acquisition unit 104, and the policy presentation unit 105 will be described below.

The communication device 904 is used by the user terminal device 300 to communicate with the authentication system 200.

The input/output device 905 includes, for example, a mouse, a keyboard, and a display.

Referring to FIG. 3, an example of the functional configuration of the policy acquisition device 100 according to this embodiment will be described next.

The authentication page acquisition unit 101 acquires an authentication page from the authentication system 200.

The authentication page is a page for the user to enter a password.

The user has registered a password in the authentication system 200 in advance. The password registered in the authentication system 200 is a password used for verification, so that it is referred to as a verification password. In the user authentication, the user enters a password in the authentication page. The authentication system 200 performs the user authentication by checking the password entered in the authentication page against the verification password.

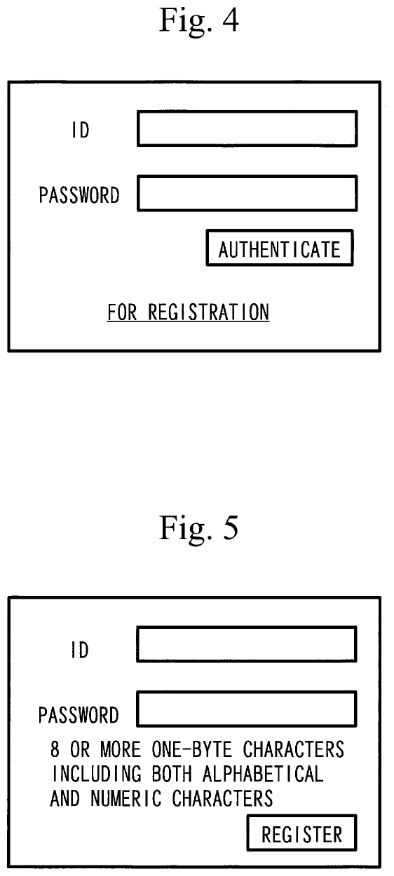

FIG. 4 illustrates an example of the authentication page. The authentication page of FIG. 4 includes an ID input form for entering an identifier (ID) of the user and a password input form for entering a password of the user.

The authentication page presentation unit 102 presents the authentication page acquired by the authentication page acquisition unit 101 to the user. The authentication page presentation unit 102 displays the authentication page on the input/output device 905 (display), for example.

The registration page acquisition unit 103 acquires a registration page from the authentication system 200.

The registration page is a page for the user to register the verification password in the authentication system 200.

FIG. 5 illustrates an example of the registration page. The registration page of FIG. 5 includes an ID input form for entering the ID of the user and a password input form for entering the password (verification password) of the user. The registration page of FIG. 5 also includes a password policy “8 or more one-byte characters including both alphabetical and numeric characters”.

The password policy indicates conditions to be satisfied by the verification password to be registered in the authentication system 200. As the password policy, “10 or more one-byte alphabetical characters” and the like may be considered in addition to “8 or more one-byte characters including both alphabetical and numeric characters” indicated in FIG. 5. The user can enter the verification password conforming to the password policy by referring to the password policy indicated in the registration page.

The policy acquisition unit 104 acquires the password policy included in the registration page acquired by the registration page acquisition unit 103.

Processing performed by the policy acquisition unit 104 is equivalent to a policy acquisition process.

When an input of the password is to be accepted from the user, the policy presentation unit 105 presents the password policy acquired by the policy acquisition unit 104 to the user. The policy presentation unit 105 displays the password policy on the input/output device 905 (display), for example.

Processing performed by the policy presentation unit 105 is equivalent to a policy presentation process.

***Description of Operation***

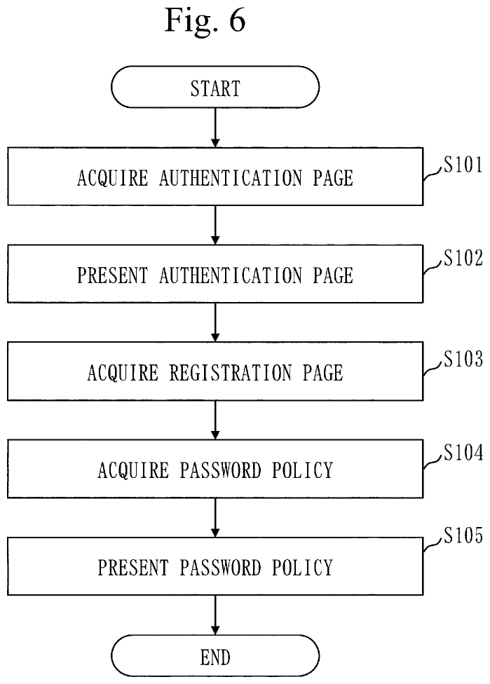

FIG. 6 illustrates an example of the operation of the policy acquisition device 100 according to this embodiment.

Referring to FIG. 6, an example of the operation of the policy acquisition device 100 according to this embodiment will be described below.

First, in step S101, the authentication page acquisition unit 101 acquires the authentication page from the authentication system 200. A method by which the authentication page acquisition unit 101 acquires the authentication page from the authentication system 200 may be any method.

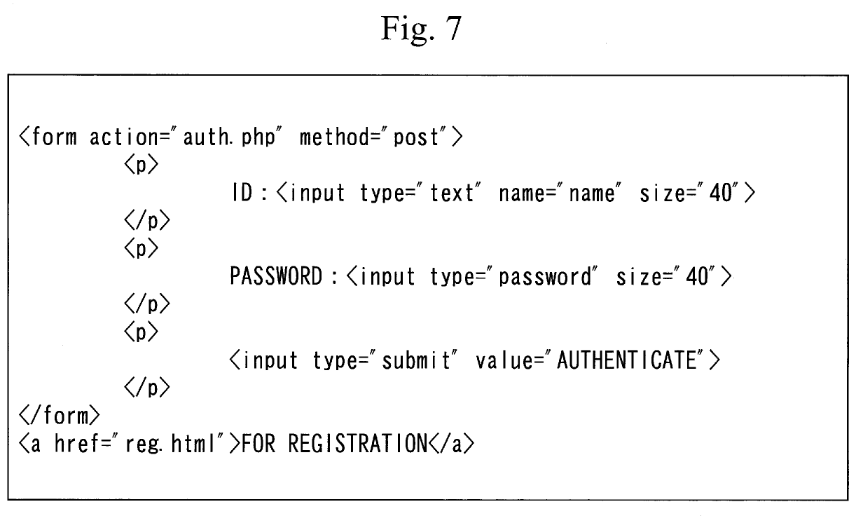

For example, when the authentication system 200 is implemented as a Web system, the authentication page acquisition unit 101 acquires html source code of the authentication page exemplified in FIG. 7 by transmitting an http request.

The following will be described assuming a case where the authentication system 200 is implemented as a Web system and the authentication page acquisition unit 101 acquires the html source code exemplified in FIG. 7 by transmitting an http request. Next, in step S102, the authentication page presentation unit 102 presents the authentication page acquired in step S101 to the user. For example, the authentication page presentation unit 102 displays the authentication page on the input/output device 905 (display).

This embodiment will be described assuming that the authentication page presentation unit 102 analyzes the html source code of FIG. 7 and displays the authentication page of FIG. 4 on the display.

Next, in step S103, the registration page acquisition unit 103 searches the authentication system 200 for the registration page, and acquires the registration page from the authentication system 200.

An algorithm for searching for and acquiring the registration page by the registration page acquisition unit 103 may be any algorithm.

In general, the authentication page often includes a link to the registration page. Therefore, it is conceivable to search for the registration page, using the link to the registration page in the authentication page.

A “link” is a mechanism for transfer to another page from a page in the authentication system 200. The link is composed of a string to be clicked in a source page (hereafter referred to as a “link string”) and a page to be a destination when the link string is clicked (hereafter referred to as a “destination page”). Since this embodiment is described assuming the Web system, the link is written as “<a href=“destination page”>link string</a>” on the html source code. On the display, the link is displayed, such as “for registration” illustrated in FIG. 4.

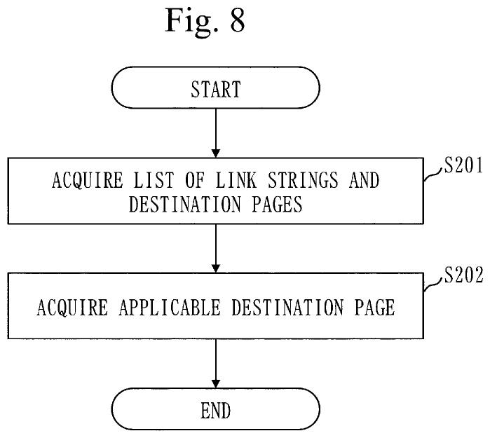

FIG. 8 illustrates an example of a procedure for acquiring the registration page from the link to the registration page in the authentication page (registration page acquisition procedure).

In step S201, the registration page acquisition unit 103 acquires link strings and destination pages of all links included in the authentication page.

It is assumed that the registration page acquisition unit 103 acquires, for example, a list such as {destination page: top.html, link string: Top page}, {destination page: reg.html, link string: for registration}.

Next, in step S202, the registration page acquisition unit 103 identifies a link string with a string pattern that is used for transfer to the registration page from the list acquired in step S201, and acquires the destination of the link string as the registration page.

The string pattern that is used for transfer to the registration page is, for example, “.*(registration|first time).*” if it is expressed in a regular expression.

Note that “.” denotes any one character, “*” denotes zero or more repeats of the immediately preceding character, and “(A|B)” denotes A or B. That is, this pattern denotes “any character string including the word or words “registration” or “first time”.

For example, link strings such as “for registration”, “first time user of this site” are included in this pattern. As a result, in the example illustrated in step S201, the registration page acquisition unit 103 identifies {destination page: reg.html, link string: for registration}, and acquires the destination page “reg.html” as the registration page.

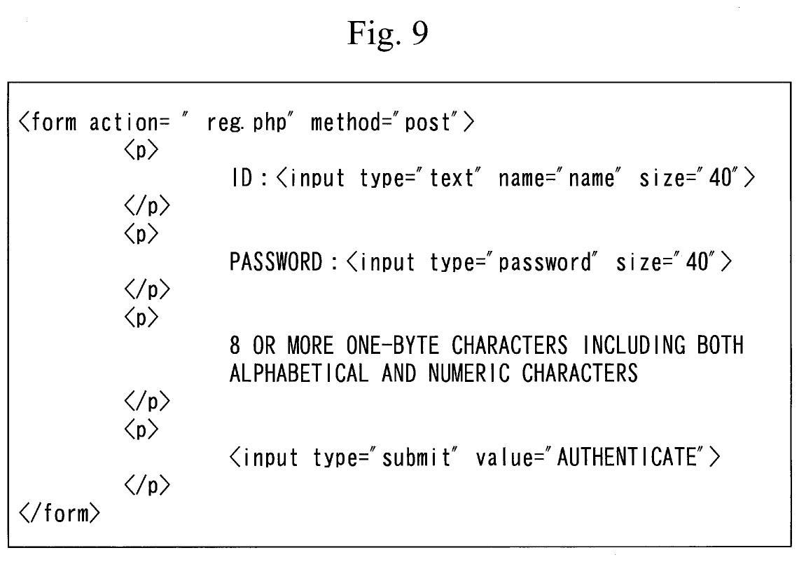

FIG. 9 illustrates an example of html source code of the acquired registration page.

The description returns to the flow of FIG. 6.

In step S104, the policy acquisition unit 104 acquires a password policy included in the registration page acquired in step S103.

An algorithm for acquiring a password policy by the policy acquisition unit 104 may be any algorithm.

A password policy is often indicated in proximity to the password input form in the registration page. For example, in the example in FIG. 5, the password policy “8 or more one-byte characters including both alphabetical and numeric characters” is indicated directly below the password input form.

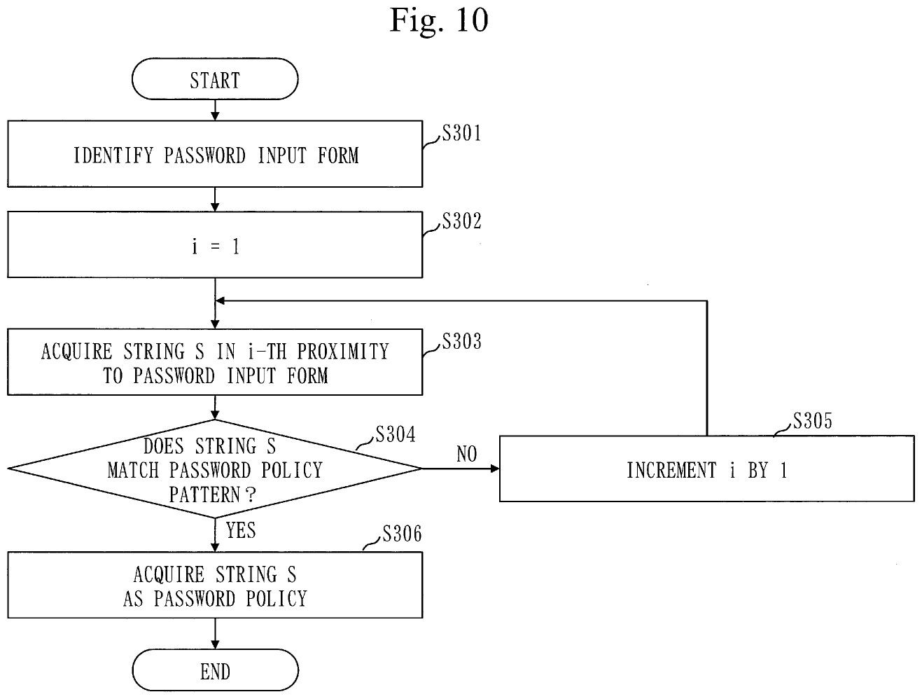

FIG. 10 illustrates an example of a procedure for acquiring a password policy in proximity to the password input form (password policy acquisition procedure).

First, in step S301, the policy acquisition unit 104 identifies the position of the password input form in the registration page. The policy acquisition unit 104 can use any algorithm to identify the position of the password input form. For example, in the authentication page generated using html source code, the password input form is generated using an html tag <input type=“password”>. Thus, the policy acquisition unit 104 can identify the position of the password input form by searching the html source code for this tag.

In step S302 and subsequent steps, the policy acquisition unit 104 sequentially extracts each string included in the registration page, starting with one in the closest proximity to the password input form, so as to acquire the password policy.

Specifically, the policy acquisition unit 104 performs the following operation.

In step S302, the policy acquisition unit 104 initializes a variable i, which represents proximity, to 1 in order to sequentially extract each string, starting with one in the closest proximity to the password input form.

Next, in step S303, the policy acquisition unit 104 acquires a string S in the i-th closest proximity to the password input form. For example, in the example in FIG. 9, the policy acquisition unit 104 acquires a string “password” when i=1 and acquires a string “8 or more one-byte characters including both alphabetical and numeric characters” when i=2.

Next, in step S304, the policy acquisition unit 104 determines whether the string S acquired in step S303 is a password policy. For example, the policy acquisition unit 104 determines whether a match occurs between a password policy pattern prepared in advance and the string S acquired in step S303.

The password policy pattern is, for example, “.*alphabet.*characters.*” if it is expressed in a regular expression. This regular expression means “a string including “alphabet” and “characters””. For example, if the pattern “.*alphabet.*characters.*” is used and if the string S is “password”, a determination result in step S304 is NO. If the string S is “8 or more one-byte characters including both alphabetical and numeric characters”, a determination result in step S304 is YES.

If the string S matches the password policy pattern (YES in step S304), processing proceeds to step S306. If the string S does not match the password policy pattern (NO in step S304), processing proceeds to step S305.

In step S305, the policy acquisition unit 104 increments i by 1 in order to acquire the next string.

In step S306, the policy acquisition unit 104 acquires the string S as the password policy.

The description returns to the flow of FIG. 6.

In step S105, the policy presentation unit 105 displays the password policy acquired in step S104 on the authentication page displayed on the display in step S102.

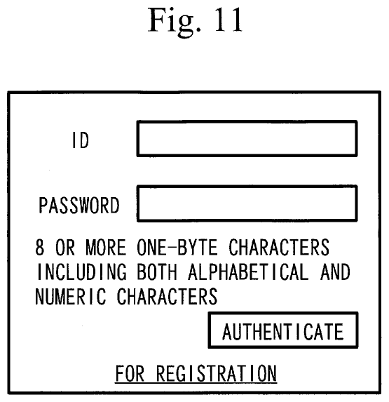

The policy presentation unit 105 displays the password policy on the authentication page, as illustrated in FIG. 11, for example.

An example is presented here where after the authentication page is displayed in step S102, the password policy is superimposed and displayed on the authentication page in step S105. Alternatively, step S102 may be omitted, and the policy presentation unit 105 may synthesize the authentication page and the password policy to generate the authentication page including the password policy, as illustrated in FIG. 11, and display this authentication page.

Alternatively, after the authentication page is displayed in step S102, the policy presentation unit 105 may display only the password policy separately from the authentication page in step S105.

***Description of Effect of Embodiment***

As described above, in this embodiment, the policy acquisition device 100 acquires a password policy and presents the password policy to a user in user authentication. Therefore, according to this embodiment, the user can enter a correct password in an authentication page in the user authentication.

<Variation 1>

In Embodiment 1, as details of step S103 in FIG. 6, the example has been described where the registration page acquisition unit 103 acquires the registration page based on the link to the registration page within the authentication page (FIG. 8).

However, there may be a case where the authentication page does not include the link to the registration page.

Therefore, in this variation, a procedure for acquiring the registration page when the authentication page does not include the link to the registration page will be described. Specifically, in this variation, the policy acquisition device 100 searches for the registration page using a link derived from a link set in the authentication page.

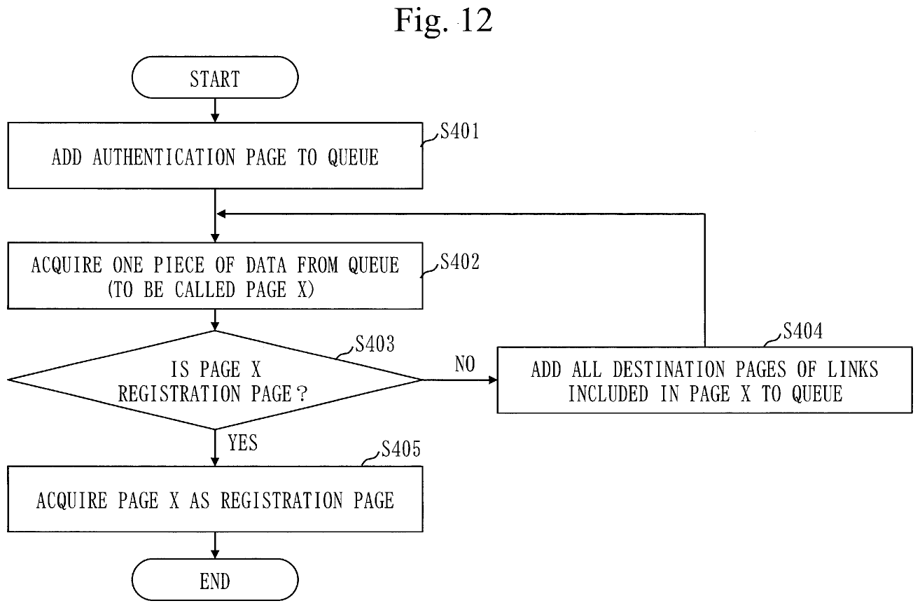

The system configuration according to this variation is as illustrated in FIG. 1. An example of the hardware configuration of the user terminal device 300 according to this variation is as illustrated in FIG. 2. An example of the functional configuration of the policy acquisition device 100 according to this variation is as illustrated in FIG. 3. In this variation, as details of step S103 of FIG. 6, operation of FIG. 12 is performed in place of operation of FIG. 8.

In this variation, differences from Embodiment 1 will be mainly described.

Matters not described below are substantially the same as those in Embodiment 1.

Referring to FIG. 12, an example of operation of the policy acquisition device 100 according to this variation will be described.

First, in step S401, the registration page acquisition unit 103 adds the authentication page to a queue.

A queue is an array that realizes first-in first-out of data. A queue in which data X1 and data X2 are stored in the order of the data X1 and the data X2 is expressed as {X1, X2}. In this case, when data X3 is added to this queue, the data X3 is added after the data X2. The queue after addition of the data X3 is expressed as {X1, X2, X3}. When data is taken out from this queue, the data X1 that has been stored first in the queue is taken out. As a result, the queue is expressed as {X2, X3}.

Next, in step S402, the registration page acquisition unit 103 acquires one piece of data (page in the authentication system 200) from the queue. The acquired data will be referred to as a page X. In operation of step S402 of the first time, since the authentication page has been stored in step S401, the registration page acquisition unit 103 acquires the authentication page.

Next, in step S403, the registration page acquisition unit 103 determines whether the page X acquired in step S402 is the registration page. The registration page acquisition unit 103 can use any algorithm to determine whether the page X is the registration page.

For example, the registration page acquisition unit 103 may determine whether the page X is the registration page by analyzing whether the page X includes characteristics of the registration page. When the authentication system 200 is a Web system, the registration page acquisition unit 103 determines that the page X includes characteristics of the registration page if, for example, “the URL of the page X includes words representing the registration page”. The registration page acquisition unit 103 may determine that the page X includes characteristics of the registration page if “the html source code of the page X includes forms for inputting an e-mail address, an ID, and a password”.

If the page X is the registration page (YES in step S403), processing proceeds to step S405. If the page X is not the registration page (NO in step S403), processing proceeds to step S404.

In step S404, the registration page acquisition unit 103 adds all the destination pages of links included in the page X to the queue.

In operation of step S404 of the first time, since the page X is the authentication page, the registration page acquisition unit 103 adds the destination pages of all links included in the authentication page to the queue. For example, if the authentication page includes links to a top page (top.html) and an enquiry page (mail.html) of the authentication system 200, the registration page acquisition unit 103 adds top.html and mail.html to the queue.

In step S405, since the page X is the registration page, the registration page acquisition unit 103 acquires the page X as the registration page.

As described above, even if the authentication page does not include the link to the registration page, the registration page acquisition unit 103 can acquire the registration page by sequentially following links derived from the links set in the authentication page by the procedure of FIG. 12.

<Variation 2>

In Embodiment 1, as details of step S104 in FIG. 6, the example has been described where the policy acquisition unit 104 acquires a password policy located in proximity to the password input form within the registration page (FIG. 10).

However, there may be a case where a password policy is not included in the registration page.

Therefore, in this variation, an example will be described where a password policy can be acquired even if the password policy is not included in the registration page. Specifically, in this variation, the policy acquisition device 100 acquires the password policy, using an error message that is presented to the user when an invalid password not conforming to the password policy is entered.

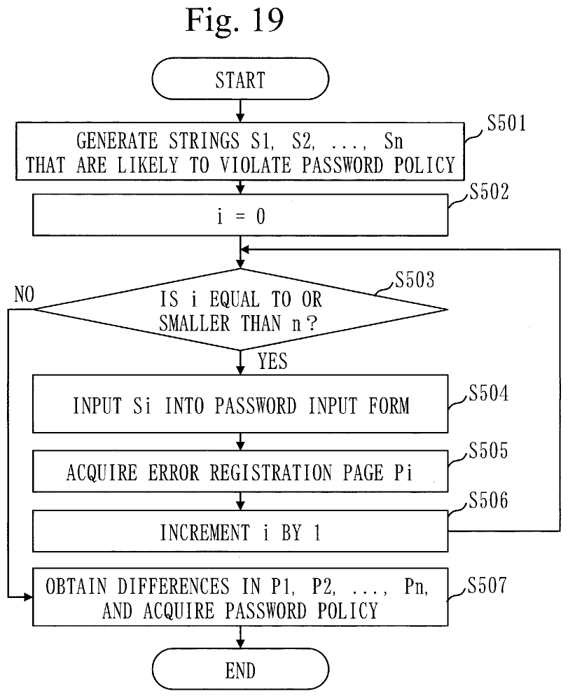

The system configuration according to this variation is as illustrated in FIG. 1. An example of the hardware configuration of the user terminal device 300 according this variation is as illustrated in FIG. 2. An example of the functional configuration of the policy acquisition device 100 according to this variation is as illustrated in FIG. 3. In this variation, as details of step S104 in FIG. 6, operation of FIG. 19 is performed in place of operation of FIG. 10.

In this variation, differences from Embodiment 1 will be mainly described.

Matters not described below are substantially the same as those in Embodiment 1.

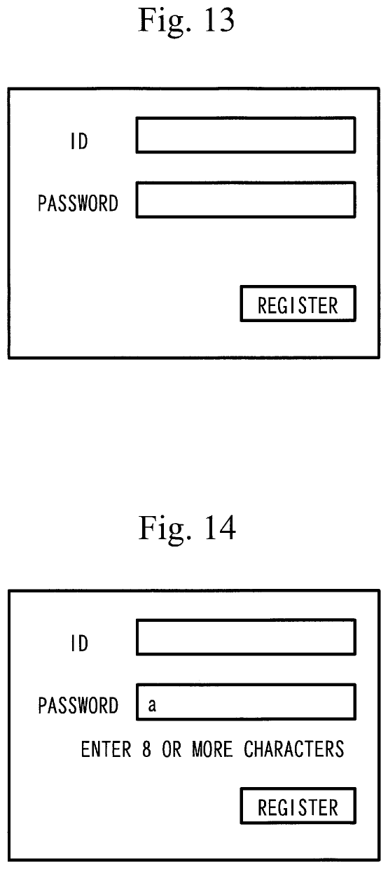

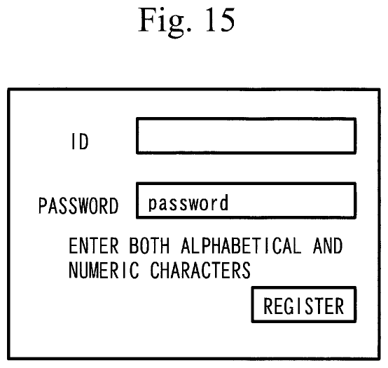

When the user enters an invalid password that does not meet the password policy into the password input form of the registration page in FIG. 13, an error message is displayed on the registration page as illustrated in FIGS. 14 and 15.

An example in FIG. 14 indicates an error message that is displayed when the user enters an invalid password of only one character. A password of 8 or more characters is specified in the password policy, so that an error message prompting the user to enter a password of 8 or more characters is displayed in the example in FIG. 14.

An example in FIG. 15 indicates an error message that is displayed when the user enters an invalid password of only alphabetical characters. A password including both alphabetical and numeric characters is specified in the password policy, so that an error message prompting the user to enter a password including both alphabetical and numeric characters is displayed in the example in FIG. 15. It is assumed that in each of FIGS. 14 and 15, the error message is displayed in red.

In the following, a registration page on which an error message is displayed as a result of entering an invalid password in the password input form, as in FIGS. 14 and 15, will be called an error registration page.

In this variation, the policy acquisition unit 104 sets an invalid password in the registration page, and acquires an error registration page. Then, the policy acquisition unit 104 acquires the password policy by analyzing an error message included in the error registration page. More specifically, the policy acquisition unit 104 sets a plurality of invalid passwords, each of which does not meet the password policy, in the registration page, and acquires a plurality of error registration pages corresponding to the plurality of invalid passwords. Then, the policy acquisition unit 104 analyzes a plurality of error messages included in the plurality of error registration pages so as to acquire the password policy.

The policy acquisition unit 104 can acquire an error registration page by any method. For example, when the authentication system 200 is implemented as a Web system, the policy acquisition unit 104 can acquire an error registration page as a Document Object Model (DOM). Alternatively, the policy acquisition unit 104 may acquire an error registration page as a screenshot of the screen.

The DOM is code for displaying a state of the registration page obtained by executing html source code.

The DOM will be described in detail below.

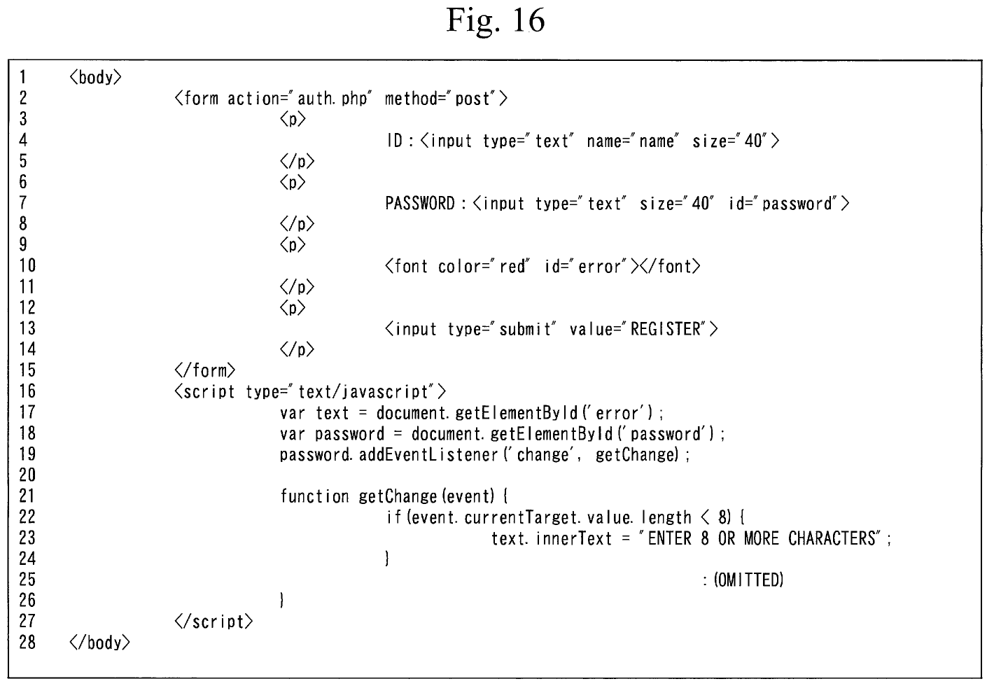

For example, in the html source code illustrated in FIG. 16, lines 2 to 15 describe the content to be displayed on the screen. Lines 16 to 27 describe changing the content to be displayed on the screen based on a string input to a password input form. Line 7 describes displaying the password input form on the screen. Furthermore, lines 22 to 24 describe determining whether a string input into the password input form is less than 8 characters, and displaying an error message if the input string is less than 8 characters. Line 10 describes displaying the error message in red.

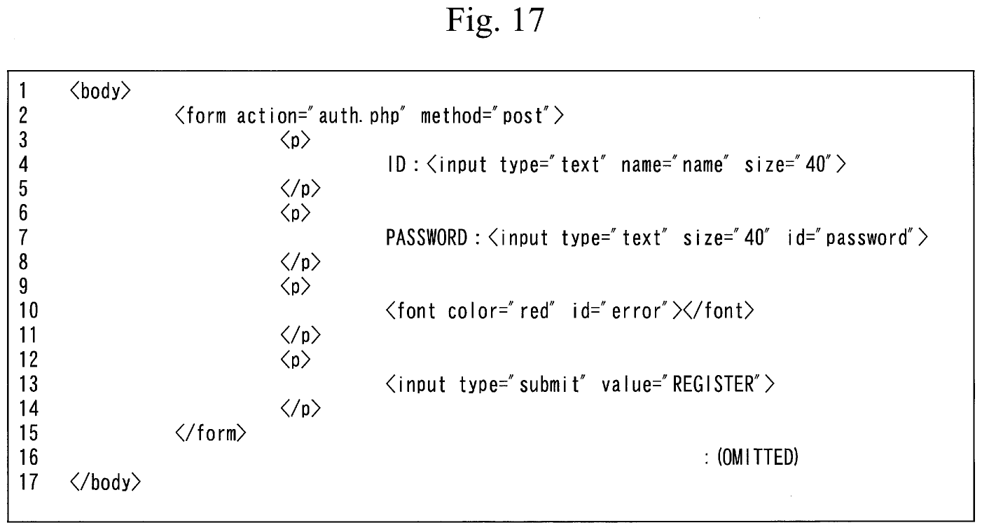

When the html source code illustrated in FIG. 16 is executed, no password is input to the password input form in the initial state, so that the DOM illustrated in FIG. 17 is generated and the registration page illustrated in FIG. 13 is displayed in the user terminal device 300.

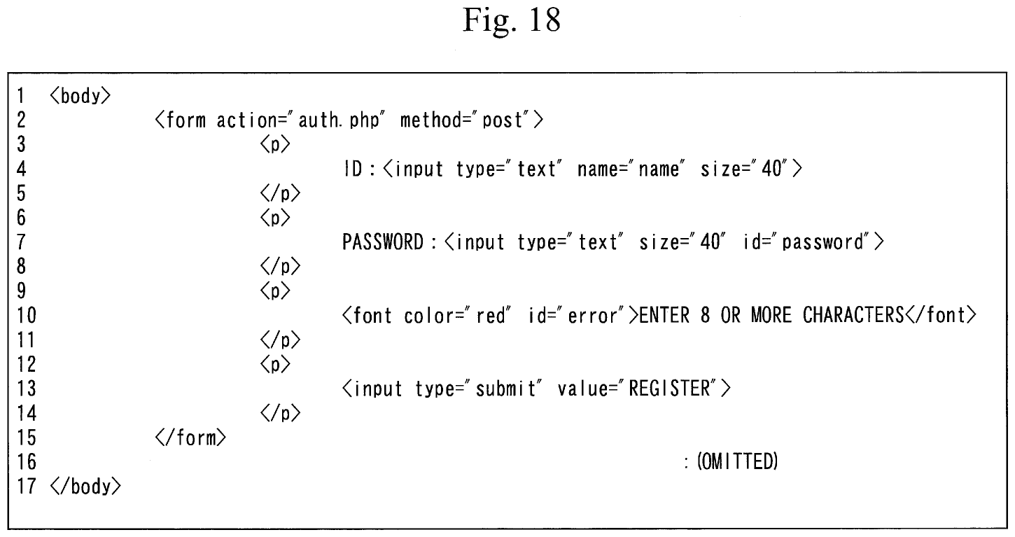

If a password consisting of only “a” is input to the password input form in the html source code of FIG. 16, the DOM illustrated in FIG. 18 is generated and the error registration page illustrated in FIG. 14 is displayed in the user terminal device 300.

FIG. 19 illustrates details of step S104 in FIG. 6 in Variation 2.

Referring to FIG. 19, an example of the operation of the policy acquisition device 100 according to Variation 2 will be described.

First, in step S501, the policy acquisition unit 104 generates n strings S1, S2, . . . , Sn that are likely to violate the password policy. The policy acquisition unit 104 generates, for example, a string with a small number of characters such as “a”, a string consisting of only alphabetical characters such as “password”, and the like.

Steps S502 to S506 are a procedure for inputting these strings S1, S2, . . . , Sn in the password input form so as to acquire error registration pages P1, P2, . . . , Pn.

In step S502, the policy acquisition unit 104 sets 0 in a counter i for referring to the string S1, S2, Sn one by one.

Next, in step S503, the policy acquisition unit 104 determines whether i is equal to or smaller than n.

If the counter i exceeds n, this means that all of the strings S1, S2, . . . , Sn have been input in the password input form and all of the error registration pages P1, P2, . . . , Pn have been acquired.

If the counter i is equal to or smaller than n (YES in step S503), processing proceeds to step S504.

If the counter i is not equal to or smaller than n (NO in step S503), processing proceed to step S507.

In step S504, the policy acquisition unit 104 inputs a string Si in the password input form in the registration page.

In step S505, the policy acquisition unit 104 acquires an error registration page Pi that is obtained as a result of inputting the string Si in the password input form in the registration page in step S504.

In step S506, the policy acquisition unit 104 increments the counter i by 1.

Then, the policy acquisition unit 104 performs processing of step S503 and subsequent steps. If the counter i after being incremented by 1 is equal to or smaller than n (YES in step S503), the policy acquisition unit 104 inputs the next string into the password input form in the registration page (step S504).

In step S507, the policy acquisition unit 104 acquires the password policy by obtaining differences in the error registration pages P1, P2, Pn.

A method by which the policy acquisition unit 104 obtains differences in the error registration pages P1, P2, Pn will be described below.

It is assumed here that the error registration pages P1, P2, Pn are acquired as DOMs. In this case, the policy acquisition unit 104 can obtain the password policy by acquiring OR (diff (Pi, Pj)) (i≠j)=OR (diff (P1, P2), diff (P1, P3), diff (P2, P3), . . . ).

Note that diff (A, B) is an operation that outputs a partial string of a DOM A not included in a DOM B. If the DOM A and the DOM B are exactly the same string, null is output. Furthermore, OR (A, B, C, . . . ) is an operation that outputs a set of values obtained by removing each duplicate string and null from “A, B, C, . . . ”. For example, OR (X, Y, X, null, Z)={X, Y, Z}.

The method by which the policy acquisition unit 104 obtains differences in the error registration pages P1, P2, Pn will be described using a specific example.

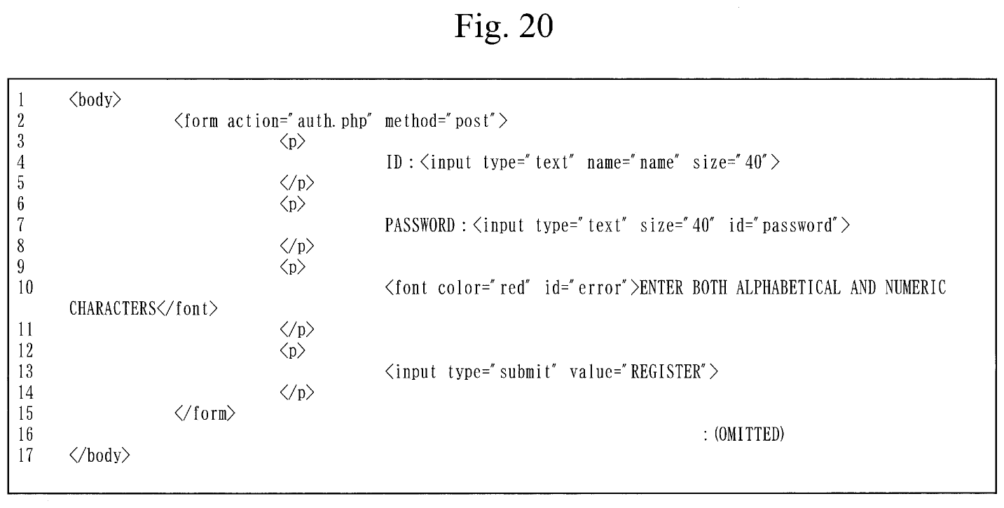

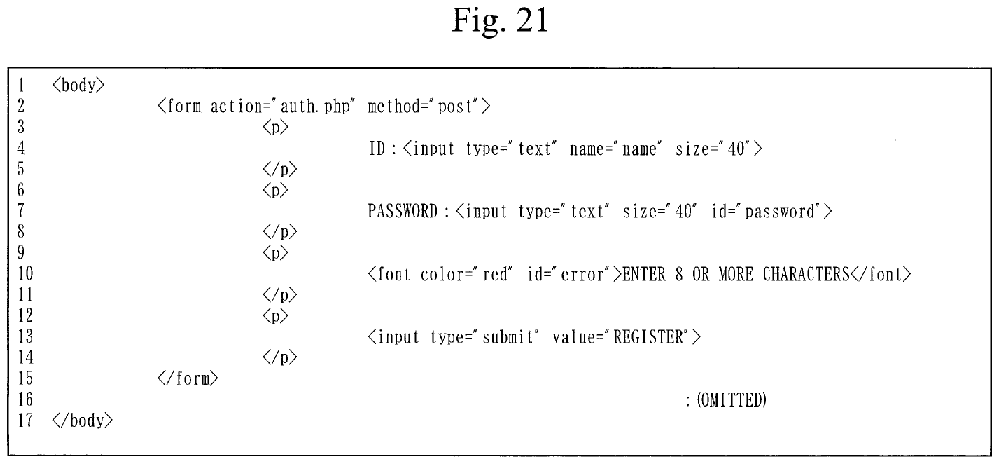

It is assumed here that a DOM in FIG. 20 and a DOM in FIG. 21 have been acquired in addition to the DOM in FIG. 18. The DOM in FIG. 18 will be hereafter referred to as an error registration page P1. The DOM in FIG. 20 will be hereafter referred to as an error registration page P2. Furthermore, the DOM in FIG. 21 will be hereafter referred to as an error registration page P3.

The DOM in FIG. 18 and the DOM in FIG. 21 are the same. In this way, P1, P2, . . . , Pn may include a plurality of instances of the same DOM.

By performing diff operations on P1 to P3, the policy acquisition unit 104 acquires the following.
diff (P1, P2)=enter 8 or more characters
diff (P1, P3)=null
diff (P2, P1)=enter both alphabetical and numeric characters
diff (P2, P3)=enter both alphabetical and numeric characters
diff (P3, P1)=null
diff (P3, P2)=enter 8 or more characters

In addition, by performing OR operations on the results of the diff operations on P1 to P3, the policy acquisition unit 104 acquires the following.
OR (diff (P1, P2), diff (P1, P3), diff (P2, P3), . . . )
=OR (enter 8 or more characters, null, enter both alphabetical and numeric characters, . . . )
={enter 8 or more characters, enter both alphabetical and numeric characters}

Based on the above, the policy acquisition unit 104 can acquire {enter 8 or more characters, enter both alphabetical and numeric characters} as the password policy.

Alternatively, if the error registration pages P1, P2, Pn are acquired as screenshots, the policy acquisition unit 104 can acquire the password policy by performing the following operations.
OR (OCR (diff_p (Pi, Pj))) (i≠j)=OR (OCR (diff_p (P1, P2)), OCR (diff_p (P1, P3)), OCR (diff_p (P2, P3)), . . . ).

Note that diff (A, B) is an operation that outputs a partial image, not included in a screenshot B, of a screenshot A. OCR (A) is an operation that recognizes a string which appears as an image on the screenshot A and outputs it as a string.

The operation of the policy acquisition unit 104 when screenshots are used will be described by focusing on differences from the operation of the policy acquisition unit 104 when DOMs are used.

It is assumed here that a screenshot in FIG. 14 and a screenshot in FIG. 15 have been acquired. The screenshot in FIG. 14 will be referred to as the error registration page P1. The screenshot in FIG. 15 will be referred to as the error registration page P2.

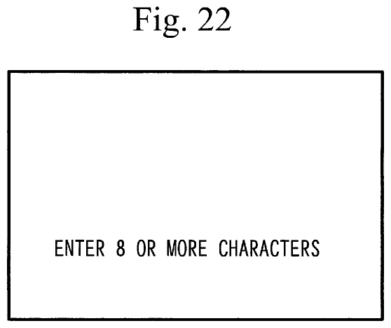

Note that diff_p (P1, P2)=FIG. 22, and OCR (diff_p (P1, P2))=enter 8 or more characters.

The rest of the operation is substantially the same as the operation of the policy acquisition unit 104 when DOMs are used, so that description will be omitted.

As described above, even if the password policy is not included in the registration page, the password policy can be acquired using the error message that is output when an invalid password is input.

<Variation 3>

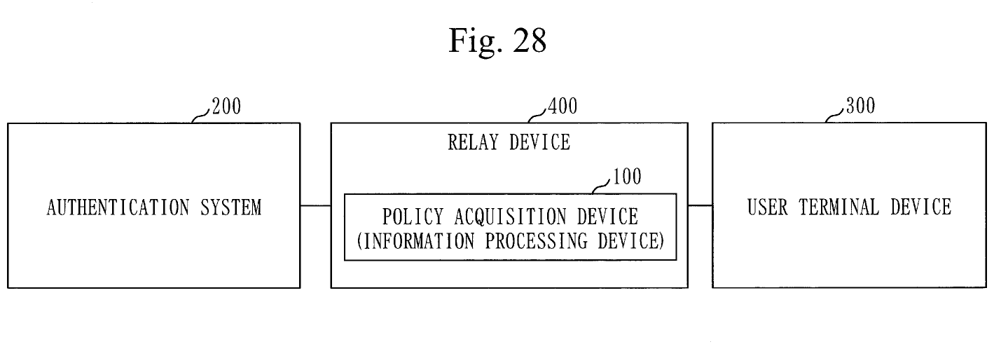

In Embodiment 1, the example has been presented where the policy acquisition device 100 is provided in the user terminal device 300, as illustrated in FIG. 1. Alternatively, as illustrated in FIG. 28, the policy acquisition device 100 may be provided in a relay device 400 that relays communication between the authentication system 200 and the policy acquisition device 100. In this case, the policy acquisition device 100 in the relay device 400 receives the authentication page, the registration page, and the password policy from the authentication system 200 by substantially the same procedure as that of the policy acquisition device 100 in Embodiment 1. Then, the policy acquisition device 100 in the relay device 400 transmits the received authentication page, registration page, and password policy to the user terminal device 300.

The policy acquisition device 100 in the relay device 400 may perform substantially the same operation as that of the policy acquisition device 100 of each of Variation 1 and Variation 2.

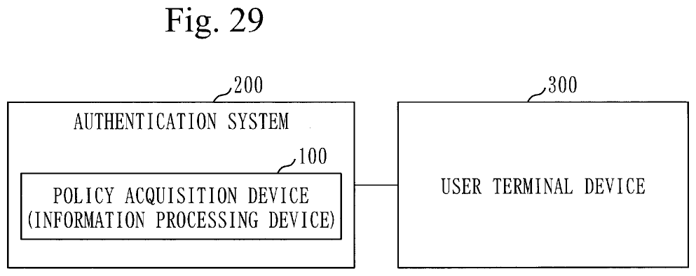

As illustrated in FIG. 29, the policy acquisition device 100 may be provided in the authentication system 200. In this case, the policy acquisition device 100 in the authentication system 200 acquires the authentication page, the registration page, and the password policy by substantially the same procedure as that of the policy acquisition device 100 of Embodiment 1. Then, the policy acquisition device 100 in the authentication system 200 transmits the acquired authentication page, registration page, and password policy to the user terminal device 300.

The policy acquisition device 100 in the authentication system 200 may perform substantially the same operation as that of the policy acquisition device 100 of each of Variation 1 and Variation 2.

### Embodiment 2

In Embodiment 1, the examples have been described where the policy acquisition device 100 acquires a password policy from the registration page of one authentication system 200, and includes the acquired password policy in the authentication page.

In this embodiment, the policy acquisition device 100 acquires password policies from the registration pages of a plurality of authentication systems 200 according to specification by the user. Then, the policy acquisition device 100 makes a list of the acquired password policies of the plurality of authentication systems 200. Then, the policy acquisition device 100 displays the list of the password policies of the plurality of authentication systems 200.

More specifically, in this embodiment, the user specifies, in the user terminal device 300, the authentication systems 200 from which the user wishes to acquire password policies, such as, for example, {authentication system A, authentication system B, authentication system C, . . . }. The policy acquisition device 100 presents a list of {password policy of authentication system A, password policy of authentication system B, password policy of authentication system C} to the user.

In this embodiment, differences from Embodiment 1 will be mainly described.

Matters not described below are substantially the same as those in Embodiment 1.

***Description of Configuration***

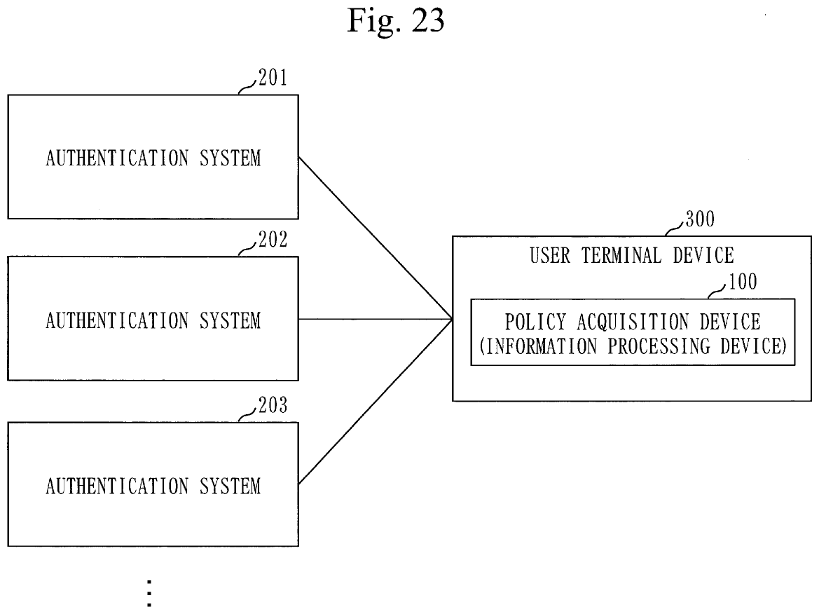

FIG. 23 illustrates an example of the system configuration according to this embodiment.

In this embodiment, the user terminal device 300 is connected with an authentication system 201, an authentication system 202, an authentication system 203, and so on. The policy acquisition device 100 acquires a password policy of each of the authentication system 201, the authentication system 202, the authentication system 203, and so on according to specification by the user.

In the following, when it is not necessary to distinguish the authentication system 201, the authentication system 202, and the authentication system 203, these will be collectively referred to as the authentication systems 200.

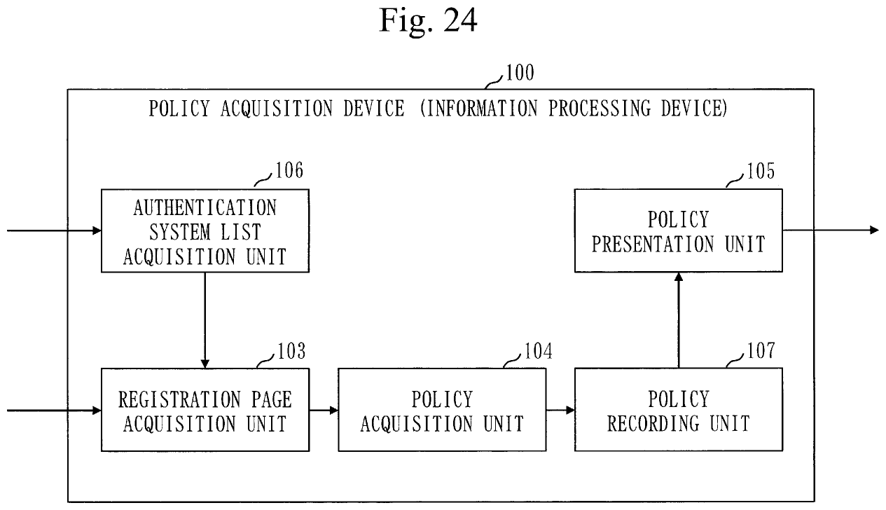

FIG. 24 illustrates an example of the functional configuration of the policy acquisition device 100 according to this embodiment.

An authentication system list acquisition unit 106 acquires an authentication system list from the user.

The authentication system list is information that lists the authentication systems 200 from which the user wishes to acquire password policies.

The authentication system list may be any information, provided that the authentication systems 200 can be identified.

For example, when each of the authentication systems 200 is implemented as a Web system, the authentication system list may be composed of Uniform Resource Locators (URLs) of pages each of which is any single page of each of the authentication systems 200. When the authentication system list is composed of URLs of pages each of which is any single page of each of the authentication systems 200, the authentication system list is arranged such as {URL of any single page in the authentication system 201, URL of any single page in the authentication system 202, . . . }. Specifically, the authentication system list is arranged as {http://www.example.com/top.html, http://www.example.org/sample.html}.

The registration page acquisition unit 103 acquires the registration pages from the authentication systems 200 indicated in the authentication system list.

The policy acquisition unit 104 is the same as that presented in Embodiment 1. That is, the policy acquisition unit 104 acquires password policies included in the registration pages acquired by the registration page acquisition unit 103.

A policy recording unit 107 records the password policies acquired by the policy acquisition unit 104.

The policy presentation unit 105 presents a list of the password policies recorded in the policy recording unit 107 to the user.

The function of the authentication system list acquisition unit 106 is also realized by a program like the registration page acquisition unit 103 and so on. The program that realizes the function of the authentication system list acquisition unit 106 is executed by the processor 901.

The policy recording unit 107 is realized by the main storage device 902 or the auxiliary storage device 903.

***Description of Operation***

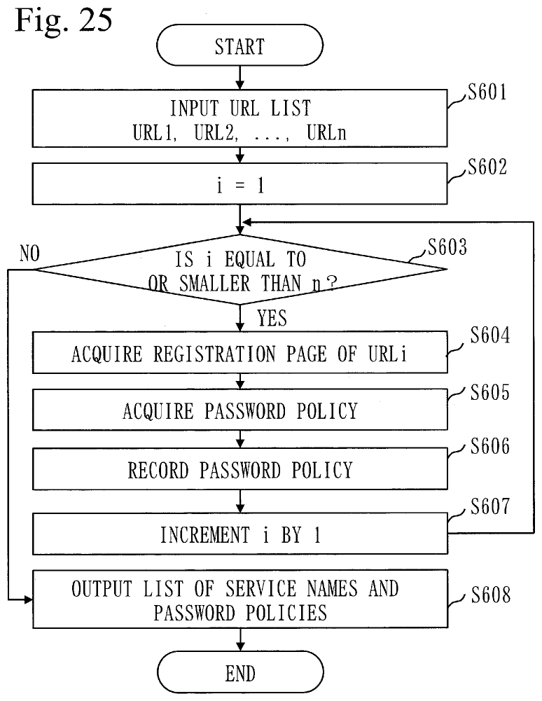

FIG. 25 illustrates an example of operation of the policy acquisition device 100 according to this embodiment.

Referring to FIG. 25, the operation of the policy acquisition device 100 according to this embodiment will be described.

In step S601, the authentication system list acquisition unit 106 acquires the authentication system list from the user via the input/output device 905 (mouse, keyboard).

It is assumed here that each of the authentication systems 200 is implemented as a Web system, and the authentication system list acquisition unit 106 acquires a URL list of the authentication systems 200. It is assumed that the URL list includes n URLs={URL1, URL2, . . . , URLn}.

The authentication system list acquisition unit 106 outputs the URL list to the registration page acquisition unit 103.

Steps S602 to S606 are operation to acquire a password policy from each authentication system 200 identified in the URL list acquired in step S601.

In step S602, the registration page acquisition unit 103 initializes the counter i as 1 in order to process the authentication systems 200 one by one.

In step S603, the registration page acquisition unit 103 determines whether the counter i is equal to or smaller than n.

If the counter i exceeds n, this means that password policies have been acquired from all of the authentication systems 200 identified in the URL list.

If the counter i is equal to or smaller than n (YES in step S603), processing proceeds to step S604.

If the counter i is not equal to or smaller than n (NO in step S603), processing proceeds to step S608.

In step S604, the registration page acquisition unit 103 acquires the registration page of URLi. The registration page acquisition unit 103 acquires the registration page of URLi by performing the operation indicated in FIG. 12. That is, the registration page acquisition unit 103 performs the operation indicated in FIG. 12 by replacing the authentication page in FIG. 12 with the page of URLi so as to acquire the registration page of URLi.

In step S605, the policy acquisition unit 104 acquires the password policy indicated in the registration page acquired in step S603. The policy acquisition unit 104 performs the same operation as that of step S104 in FIG. 6.

In step S606, the policy recording unit 107 records the password policy acquired in step S605.

For example, if the password policy of URL1 is “8 or more characters including both alphabetical and numeric characters”, the policy recording unit 107 records {URL1: 8 or more characters including both alphabetical and numeric characters}. Then, if “16 or more alphabetical characters” is acquired as the password policy of URL2, the password policy of URL2 is added to the password policy of URL1. As a result, the policy recording unit 107 records {URL1: 8 or more characters including both alphabetical and numeric characters, URL2: 16 or more alphabetical characters”.

In step S607, the registration page acquisition unit 103 increments the counter i by 1 in order to perform processing for the next authentication system 200.

In step S608, the policy presentation unit 105 displays a list of n password policies recorded in the policy recording unit 107 on the input/output device 905 (display).

The policy presentation unit 105 displays the plurality of authentication systems 200 by associating each of the authentication systems 200 with a corresponding one of the password policies, such as, for example, {URL1: 8 or more characters including both alphabetical and numeric characters, URL2: 16 or more alphabetical characters, . . . }.

***Description of Effect of Embodiment***

As described above, according to this embodiment, it is possible to collect password policies from registration pages of a plurality of authentication systems 200, and present a list of the password policies of the plurality of authentication systems 200 to the user.

<Variation 1>

In Embodiment 2, the user inputs the authentication system list. However, it takes time and effort for the user to input the authentication system list. Therefore, it is desirable to save the time and effort for inputting the authentication system list.

Therefore, in Variation 1, when each of the authentication systems 200 is implemented as a Web system, the policy acquisition device 100 uses a crawler such a search engine to generate the authentication system list. That is, in Variation 1, when the user specifies service names of the authentication systems 200, the policy acquisition device 100 uses the crawler to acquire URLs of Web pages of the authentication systems 200, based on the service names specified by the user. This can save the time and effort of the user for inputting the URLs of Web pages of the authentication systems 200 as the authentication system list.

In this variation, differences from Embodiment 2 will be mainly described.

Matters not described below are substantially the same as those in Embodiment 2.

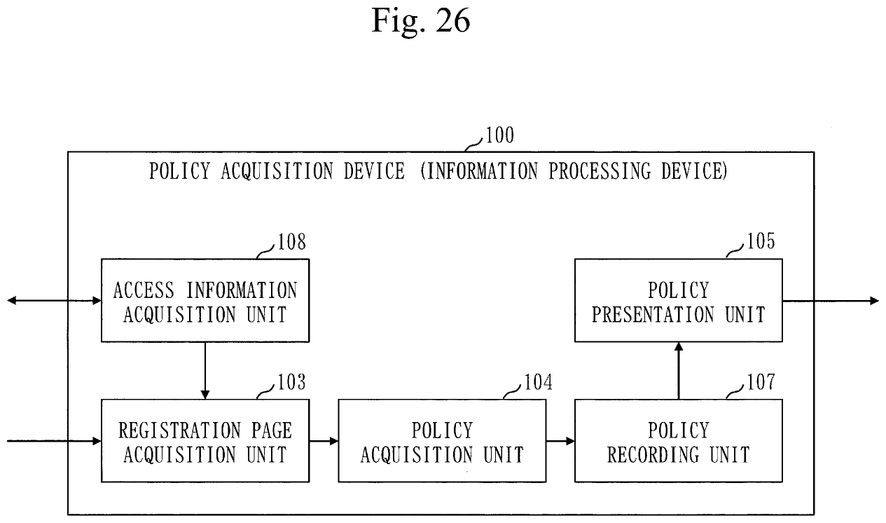

FIG. 26 illustrates an example of the functional configuration of the policy acquisition device 100 according to Variation 1.

An access information acquisition unit 108 acquires a service name list from the user.

The service name list is a list of service names of the authentication systems 200 from which the user wishes to acquire password policies.

The service names indicated in the service name list may be any information, provided that it is information that can identify the authentication systems 200. A service name is, for example, a company name. For example, if the user wishes to acquire a password policy of the authentication system 200 of XYZ Corporation, the user includes “XYZ”, which is the company name, in the service name list.

The access information acquisition unit 108 notifies the crawler, such as a search engine, of each service name indicated in the service name list. Then, the access information acquisition unit 108 acquires the URL of the Web page corresponding to each service name from the crawler as information for accessing the authentication system 200.

As mentioned above, if “XYZ” is included in the service name list, the access information acquisition unit 108 notifies the crawler of “XYZ”. Specifically, the access information acquisition unit 108 instructs the crawler to perform a search using “XYZ” as a search word. As a result, the access information acquisition unit 108 acquires the URL of the Web page of XYZ Corporation from the crawler.

The function of the access information acquisition unit 108 is also realized by a program, like the registration page acquisition unit 103 and so on. The program that realizes the function of the access information acquisition unit 108 is executed by the processor 901.

Other constituent elements illustrated in FIG. 26 are the same as those illustrated in FIG. 24. Therefore, description of these will be omitted.

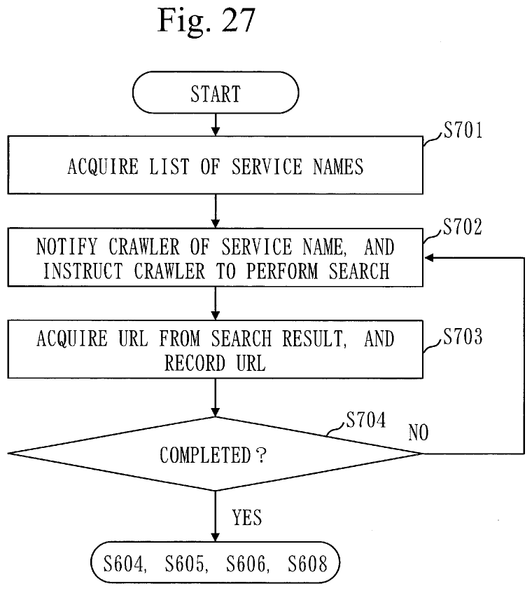

FIG. 27 illustrates an example of operation of the access information acquisition unit 108.

Referring to FIG. 27, the operation of the access information acquisition unit 108 will be described below.

In step S701, the access information acquisition unit 108 acquires the service name list from the user via the input/output device 905 (mouse, keyboard).

Next, in step S702, the access information acquisition unit 108 notifies the crawler of a service name included in the service name list acquired in step S701, and instructs the crawler to perform a search using the service name as a search word.

In step S703, the access information acquisition unit 108 acquires a search result from the crawler, acquires a URL from the search result, and stores the acquired URL in, for example, the main storage device 902 or the auxiliary storage device 903.

In step S703, the access information acquisition unit 108 can acquire the URL from the search result by any method. For example, the access information acquisition unit 108 can acquire the URL that appears at the top of the search result.

If there is a URL that has been recorded in previous processing, the access information acquisition unit 108 stores the newly acquired URL in addition to the recorded URL. For example, the access information acquisition unit 108 stores URLs in a format such as {URL1, URL2, URL3, . . . }.

In step S704, the access information acquisition unit 108 determines whether URLs have been acquired for all the service names included in the service list.

If URLs have been acquired for all the service names (YES in step S704), then steps S604, S605, S606, and S608 of FIG. 25 are performed using the acquired URLs. That is, the policy acquisition unit 104 accesses each of the authentication systems 200, using a corresponding one of the acquired URLs, so as to acquire a registration page and a password policy from each of the authentication systems 200. Then, the policy presentation unit 105 displays the password policy of each of the authentication systems 200 on the display.

If there is a service name whose URL has not been acquired (NO in step S704), processing returns to step S702.

As described above, according to Variation 1, it is possible to save the time and effort of the user for inputting URLs of Web pages of a plurality of authentication systems 200.

Embodiment 1 and Embodiment 2 including variations have been described above. These embodiments may be implemented in combination.

Alternatively, one of these embodiments may be partially implemented.

Alternatively, these embodiments may be partially implemented in combination.

The configurations and procedures described in these embodiments may be changed as necessary.

***Supplementary Description of Hardware Configuration***

Lastly, the hardware configuration of the user terminal device 300 will be described supplementarily.

When the policy acquisition device 100 is provided in the relay device 400 or the authentication system 200 as presented in Variation 3 of Embodiment 1, it is assumed that the processor 901, the main storage device 902, the auxiliary storage device 903, the communication device 904, and the input/output device 905 are also provided in “the relay device 400” or “the authentication system 200”. It is also assumed that “the user terminal device 300” in the following description is interpreted as “the relay device 400” or “the authentication system 200”.

The processor 901 illustrated in FIG. 2 is an integrated circuit (IC) that performs processing.

The processor 901 is a central processing unit (CPU), a digital signal processor (DSP), or the like.

The main storage device 902 illustrated in FIG. 2 is a random access memory (RAM).

The auxiliary storage device 903 illustrated in FIG. 2 is a read only memory (ROM), a flash memory, a hard disk drive (HDD), or the like.

The communication device 904 illustrated in FIG. 2 is an electronic circuit that performs data communication processing.

The communication device 904 is, for example, a communication chip or a network interface card (NIC).

The auxiliary storage device 903 also stores an operating system (OS).

At least part of the OS is executed by the processor 901.

The processor 901 executes the programs that realize the functions of the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 while executing at least part of the OS.

Task management, memory management, file management, communication control, and so on are performed by the processor 901 executing the OS.

At least one of information, data, signal values, and variable values indicating results of processing by the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 is stored in at least one of the main storage device 902, the auxiliary storage device 903, a register in the processor 901, and a cache memory in the processor 901.

Each of the programs that realize the functions of the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 may be stored in a portable recording medium, such as a magnetic disk, a flexible disk, an optical disc, a compact disc, a Blu-ray (registered trademark) disc, or a DVD. The portable recording media storing the programs that realize the functions of the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 may be distributed.

“Unit” of each of the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 may be interpreted as “circuit”, “step”, “procedure”, “process”, or “circuitry”.

The user terminal device 300 may be realized by a processing circuit. The processing circuit is, for example, a logic integrated circuit (IC), a gate array (GA), an application specific integrated circuit (ASIC), or a field-programmable gate array (FPGA).

In this case, each of the authentication page acquisition unit 101, the authentication page presentation unit 102, the registration page acquisition unit 103, the policy acquisition unit 104, the policy presentation unit 105, the authentication system list acquisition unit 106, and the access information acquisition unit 108 is realized as part of the processing circuit.

In this specification, a broader concept of the processor and the processing circuit is called “processing circuitry”.

That is, each of the processor and the processing circuit is a specific example of the “processing circuitry”.

### REFERENCE SIGNS LIST

100: policy acquisition device, 101: authentication page acquisition unit, 102: authentication page presentation unit, 103: registration page acquisition unit, 104: policy acquisition unit, 105: policy presentation unit, 106: authentication system list acquisition unit, 107: policy recording unit, 108: access information acquisition unit, 200: authentication system, 201: authentication system, 202: authentication system, 203: authentication system, 300: user terminal device, 400: relay device, 901: processor, 902: main storage device, 903: auxiliary storage device, 904: communication device, 905: input/output device.

1. An information processing device comprising
processing circuitry to:
acquire a password policy prescribed in an authentication system that performs user authentication using a password, and
present the acquired password policy to a user when the authentication system is to accept an input of a password from the user for the user authentication,
wherein the processing circuitry acquires the password policy from a registration page that includes the password policy and is presented to the user by the authentication system when a verification password is to be registered in the authentication system, the verification password being a password against which a password input in the user authentication is checked by the authentication system.

2. The information processing device according to claim 1,
wherein the processing circuitry searches for the registration page, using a link set in an authentication page that is presented to the user by the authentication system in the user authentication.

3. The information processing device according to claim 2,
wherein the processing circuitry searches for the registration page, using a link derived from the link set in the authentication page.

4. An information processing device comprising
processing circuitry to:
acquire a password policy prescribed in an authentication system that performs user authentication using a password, and
present the acquired password policy to a user when the authentication system is to accept an input of a password from the user for the user authentication,
wherein the processing circuitry acquires the password policy, using an error message that is presented to the user by the authentication system when an invalid password not conforming to the password policy is input.

5. The information processing device according to claim 4,
wherein the processing circuitry acquires the error message by setting the invalid password in a registration page for registering a password, and acquires the password policy, using the acquired error message.

6. The information processing device according to claim 5,
wherein the processing circuitry sets a plurality of invalid passwords, each not conforming to the password policy, in the registration page, acquires a plurality of error messages corresponding to the plurality of invalid passwords, and acquires the password policy, using the plurality of error messages that have been acquired.

7. The information processing device according to claim 1,
wherein the processing circuitry includes the password policy in an authentication page that is presented to the user by the authentication system in the user authentication.

8. The information processing device according to claim 1,
wherein the processing circuitry acquires a plurality of password policies prescribed in a plurality of authentication systems, and
wherein the processing circuitry presents each of the acquired plurality of password policies in association with a corresponding authentication system of the plurality of authentication systems.

9. The information processing device according to claim 8,
wherein the processing circuitry uses a crawler to acquire a plurality of pieces of access information for accessing the plurality of authentication systems, and
wherein the processing circuitry accesses the plurality of authentication systems, using the plurality of pieces of access information, and acquires the plurality of password policies from the plurality of authentication systems.

10. An information processing method comprising:
acquiring a password policy prescribed in an authentication system that performs user authentication using a password; and
presenting the acquired password policy to a user when the authentication system is to accept an input of a password from the user for the user authentication,
wherein the password policy is acquired from a registration page that includes the password policy and is presented to the user by the authentication system when a verification password is to be registered in the authentication system, the verification password being a password against which a password input in the user authentication is checked by the authentication system.

11. An information processing method comprising:
acquiring a password policy prescribed in an authentication system that performs user authentication using a password; and
presenting the acquired password policy to a user when the authentication system is to accept an input of a password from the user for the user authentication,
wherein the password policy is acquired, using an error message that is presented to the user by the authentication system when an invalid password not conforming to the password policy is input.

12. A non-transitory computer readable medium storing an information processing program to cause a computer to execute:
a policy acquisition process of acquiring a password policy prescribed in an authentication system that performs user authentication using a password; and
a policy presentation process of presenting the password policy acquired by the policy acquisition process to a user when the authentication system is to accept an input of a password from the user for the user authentication,
wherein in the policy acquisition process, the information processing program causes the computer to acquire the password policy from a registration page that includes the password policy and is presented to the user by the authentication system when a verification password is to be registered in the authentication system, the verification password being a password against which a password input in the user authentication is checked by the authentication system.

13. A non-transitory computer readable medium storing an information processing program to cause a computer to execute:
a policy acquisition process of acquiring a password policy prescribed in an authentication system that performs user authentication using a password; and
a policy presentation process of presenting the password policy acquired by the policy acquisition process to a user when the authentication system is to accept an input of a password from the user for the user authentication,
wherein in the policy acquisition process, the information processing program causes the computer to acquire the password policy, using an error message that is presented to the user by the authentication system when an invalid password not conforming to the password policy is input.

14. The information processing device according to claim 4,
wherein the processing circuitry includes the password policy in an authentication page that is presented to the user by the authentication system in the user authentication.

15. The information processing device according to claim 4,
wherein the processing circuitry acquires a plurality of password policies prescribed in a plurality of authentication systems, and
wherein the processing circuitry presents each of the acquired plurality of password policies in association with a corresponding authentication system of the plurality of authentication systems.

16. The information processing device according to claim 15,
wherein the processing circuitry uses a crawler to acquire a plurality of pieces of access information for accessing the plurality of authentication systems, and
wherein the processing circuitry accesses the plurality of authentication systems, using the plurality of pieces of access information, and acquires the plurality of password policies from the plurality of authentication systems.
